(19) United States
(12) Patent Application Publication
(10) Pub. No.: US 2025/0070207 A1
(43) Pub. Date: Feb. 27, 2025

(54) METHOD FOR COOLING A FUEL CELL SYSTEM AND FUEL CELL SYSTEM

(71) Applicant: Robert Bosch GmbH, Stuttgart (DE)

(72) Inventors: Jonas Breitinger, Stuttgart (DE); Mark Hellmann, Korntal (DE)

(21) Appl. No.: 18/724,340

(22) PCT Filed: Dec. 23, 2022
(86) PCT No.: PCT/EP2022/087771

§ 371 Date: Jun. 26, 2024

(30) Foreign Application Priority Data
Jan. 10, 2022 (DE) 10 2022 200 134.6

(51) Int. Cl. H01M 8/04746; H01M 8/04007; H01M 8/04029; H01M 8/0432; H01M 8/04492; H01M 8/04537; H01M 8/04664

(52) U.S. Cl. CPC H01M 8/04768; H01M 8/04029; H01M 8/04074; H01M 8/0432; H01M 8/04492; H01M 8/04634; H01M 8/04679

(57) ABSTRACT

The invention relates to a method for cooling a fuel cell system by operating a cooling system, comprising a coolant pump, a cooler through which coolant can flow, a bypass with a bypass valve for selectively, at least partially bridging the cooler, and a coolant passage of a fuel cell stack thermally coupled to the fuel cell system, said method comprising the following steps: determining a flooding risk of the fuel cell system at least once according to current operating conditions of the fuel cell system; determining a maximum permissible temperature gradient based on the determined flooding risk; operating the coolant pump such that it conveys a volumetric flow of a coolant through the coolant passages of the stack and the cooler; actuating the bypass valve such that it divides the volumetric flow through the bypass and the cooler; and limiting a cooling output by limiting the volumetric flow and a status of the bypass valve in order to limit the temperature gradient to the determined maximum permissible temperature gradient.

### BACKGROUND

The present invention relates to a method for cooling a fuel cell system and to a fuel cell system which can be cooled by such a method.

In vehicles in which, among other things, drive energy is also supplied by fuel cells, the oxidizing agent (oxygen from the ambient air) is generally used to react with hydrogen to form water in the fuel cell and thus to supply electrical output by means of electrochemical conversion. The electrochemical process generates heat that must be dissipated. The operating temperature should be kept within a certain temperature range to ensure efficient and low-degradation operation. Particularly in high-load phases, a fuel cell stack generates considerable amounts of heat, which must be dissipated via a cooling system in order to avoid excessive heating of the cell membrane and prevent irreversible damage. For this reason, high-output cooling systems are installed in modern fuel cell systems, which are designed for high loads. In cases at a low load and the associated low heat output, however, the cooling system is considerably oversized, which can result in strong gradients in the coolant temperature.

Such a cooling system enables the fuel cell stack to cool down so quickly that flooding or greatly reduced electrode kinetics could occur in individual fuel cells. In this state, the condensation of liquid water could influence the supply of reactants to the individual fuel cells at the respective active layer. As a result, the cell voltage achieved could be reduced, and thus also the output, and ageing processes may be intensified.

### SUMMARY

One object of the invention is to propose a method for cooling a fuel cell system which is capable of cooling a fuel cell system, while at the same time preventing flooding or greatly reduced electrode kinetics by lowering the coolant temperature too quickly, as well as enabling the greatest possible temperature dynamics.

The invention relates to a method for cooling a fuel cell system by operating a cooling system, comprising a coolant pump, a cooler through which coolant can flow, a bypass with a bypass valve for selectively, at least partially bridging the cooler, and a coolant passage of a stack thermally coupled to the fuel cell system, said method comprising the following steps: determining a flooding risk of the fuel cell system at least once according to current operating conditions of the fuel cell system; determining a maximum permissible temperature gradient based on the determined flooding risk; operating the coolant pump such that it conveys a volumetric flow of a coolant through the coolant passages of the stack and the cooler; actuating the bypass valve such that it divides the volumetric flow through the bypass and the cooler; and limiting a cooling output by limiting the volumetric flow and a status of the bypass valve in order to limit the temperature gradient to the determined maximum permissible temperature gradient.

The method according to the invention enables limitation of a rotational speed of the coolant pump and a position of the bypass valve or, in general, a maximum activated cooling capacity depending on the expected and/or actual operating state. The service life is thus increased by avoiding thermally induced flooding and accelerating cooling due to more precise knowledge of the permissible cooling rate.

Using a current cooling system, very high temperature gradients of up to 6 K/s can be achieved. However, in operating states at a low fuel cell stack output, only little heat is generated, so a reduction in the coolant temperature leads directly to a reduction in the cell temperature. Particularly near the active layer of a fuel cell, this rapid temperature reduction results in a significant reduction in the saturation vapor pressure in addition to the reduction in kinetics, while the water concentration hardly changes. Consequently, a supersaturated state can result, leading to local condensation of liquid water. The liquid water hinders the supply of reactants.

The rotational speed of the coolant pump and the position of the bypass valve can be regulated in an actual system in order to influence the change in coolant temperature. If the cooling rate is limited in line with the operating state, unwanted flooding can be prevented because the cooling rate of the fuel cell stack is also limited thereby.

Various approaches can be used to identify operating points having a high flooding risk. Examples in this context include model-based and experimental analyses. Particularly at low current densities, at which little heat loss occurs in the active layer, and under humid operating conditions, the cooling rate of the cooling system, which is generally oversized for this case, must be limited. This information is used during operation to modify the regulation of the bypass valve and the coolant pump. A corresponding limitation of the volumetric flow delivered by the coolant pump and a status of the bypass valve can in this case be performed individually or together.

It may in this case be advantageous to ensure that the rotational speed of the coolant pump and the associated volumetric flow of coolant are not reduced below a lower limit. At very low volumetric flows, there could otherwise be a risk of causing very nonhomogeneous temperature distributions in the individual fuel cells, which could result in damage to the membrane due to locally high temperatures.

The method can be used for the ongoing operation of a fuel cell system as well as for one-off events, such as cooling down when the fuel cell system is shut down.

The flooding risk of the fuel cell system could, e.g., be determined using a mathematical simulation model, a calculation rule, or based on experimentally determined data. To this end, the current operating conditions could, e.g., first be recorded by measuring the current and voltage parameters on the fuel cell stack, based on which the output loss of the fuel cells can be determined. The risk of flooding is particularly present if the fuel cell system is operated at low load, because then only a low output loss is present in the active layers, and a high cooling output leads to a very immediate reduction in the temperature at the active layer. A fuel cell stack is conventionally operated at a moderate and stationary stable humidity. Due to transient processes including, e.g., load changes, as a result of which changes in water production, pressure, temperature, mass flow, and the like take place, deviations towards drier and more humid operating conditions regularly occur during actual operation. The combination of humid operating conditions and low output loss may therefore increase the risk of flooding. If the stoichiometry is as ideal as possible, it can be assumed that the water produced is better discharged from the fuel cells, so a higher temperature gradient could be permitted.

A maximum permissible temperature gradient can be determined based on the determined flooding risk. This could be performed based on a calculation rule or based on experimentally determined data, e.g. in the form of a look-up table. The flooding risk could be determined based on a simplified physical model. An empirical determination of critical states by analyzing measurement data would be conceivable. It would also be possible to use a machine learning algorithm to identify critical states. The algorithm is in this case trained using data obtained based on tests or more detailed simulations. A maximum permissible rotational speed of the coolant pump and a permissible position of the bypass valve can be directly derived on this basis.

Overall, the method is therefore able to perform adapted, optimized cooling of a fuel cell system, whereby flooding of the fuel cells is prevented.

The actuation could be performed in at least a predictive manner. The predictive limitation of the cooling output can be based on the consideration of various parameters. The achievable cooling output depends on the cooling capacity of the cooler, the ambient temperature of the vehicle in which the fuel cell system is installed, as well as its speed. Estimating the cooling output required to maintain an operating temperature can be achieved by considering an expected output requirement. The method thus provides a corresponding precontrol process, and the cooling output is limited as a precaution in order to avoid the flooding risk.

Alternatively, the actuation could also be based on measurement data or an estimated status of the fuel cell system in a feedback regulation process. Based on measurement data or an estimated status of the fuel cell stack as a feedback loop, an active and constantly updated limitation of the cooling output can be performed. For example, a temperature gradient of the fuel cell stack could for this purpose be compared with a specified maximum (negative) temperature gradient. If the actual, current temperature gradient is greater than the specified maximum temperature gradient, then the cooling output able to be provided by the cooling system can be limited.

The method could thus comprise comparing a temperature gradient of the fuel cell system with the maximum temperature gradient, whereby the cooling output is reduced if the temperature gradient exceeds the maximum temperature gradient. In this context, the temperature gradient is understood to mean the amount of change in the temperature of the fuel cell system over time in a negative direction, i.e. in the cooling direction. If the temperature gradient is higher than the specified maximum temperature gradient, the cooling is therefore too strong. The temperature gradient can be determined by monitoring at least one temperature of the fuel cell system, e.g. by means of one or more temperature sensors on a bipolar plate, and/or an exhaust air outlet, and/or on a coolant outlet, and/or the like.

Determining the flooding risk could further comprise sensing a relative humidity at a cathode input and/or an anode input, whereby the maximum permissible temperature gradient is reduced as the relative humidity increases. Very humid inlet conditions lead to increased channel humidity, thus reducing the maximum permissible cooling rate.

Determining the flooding risk could also comprise detecting a current temperature in the fuel cell system and comparing it with a target temperature, whereby the maximum temperature gradient is selected to be greater as the difference between the current temperature and the target temperature decreases. The saturation vapor pressure is strongly temperature-dependent and, particularly at higher temperatures, cooling results in a significant reduction in the saturation vapor pressure. In this case, the flooding risk is increased. However, if the difference from the target temperature is small, a higher cooling rate can be selected because the change in saturation vapor pressure is smaller.

Determining the flooding risk can comprise estimating the humidity of a membrane of the fuel cell system by means of an impedance measurement, whereby the maximum temperature gradient is increased at a lower humidity of the membrane. Using an impedance measurement at high frequency, i.e. a measurement of a high-frequency resistance, the membrane conductivity, and thus the water content of the membrane, can be estimated. Conclusions can then be made about the humidity state of the adjoining active layer. If a high level of resistance is measured, then the membrane tends to be dry and there is less risk of flooding the adjoining layers.

The invention further relates to a fuel cell system comprising at least one fuel cell stack, a cooling system which has a coolant pump, a cooler through which coolant can flow, a bypass with a bypass valve for selectively, at least partially, bridging the cooler at least partially and coolant passages of the stack which are thermally coupled to the fuel cell system, and a control unit coupled to the cooling system, whereby the control unit is designed for determining a flooding risk of the fuel cell system at least once according to current operating conditions of the fuel cell system; determining a maximum permissible temperature gradient based on the determined flooding risk; operating the coolant pump such that it conveys a volumetric flow of a coolant through the coolant passages of the stack and the cooler; actuating the bypass valve such that it divides the volumetric flow through the bypass and the cooler; and limiting a cooling output by limiting the volumetric flow and a status of the bypass valve in order to limit the temperature gradient to the determined maximum permissible temperature gradient.

The control unit could be designed to determine the flooding risk by detecting a relative humidity at a cathode input and/or an anode input, whereby the maximum permissible temperature gradient is reduced as the relative humidity increases, and/or by detecting a current temperature in the fuel cell system and comparing it with a target temperature, whereby the maximum temperature gradient is selected to be greater as the difference between the current temperature and the target temperature decreases.

The fuel cell system could further comprise an impedance measuring device, whereby the control unit is designed to perform the flooding risk by estimating the water content of a membrane of the fuel cell system by means of an impedance measurement by the impedance measuring device, whereby the maximum temperature gradient is increased at a lower water content of the membrane.

### BRIEF DESCRIPTION OF THE DRAWINGS

Further measures improving the invention are described in greater detail hereinafter, together with the description of the preferred exemplary embodiments of the invention, with reference to the drawings.

Exemplary embodiments

Shown are:

FIG. 1 a schematic illustration of a fuel cell system;

FIG. 2 a schematic illustration of a method;

FIGS. 3a, 3b, 3c diagrams with output loss and cooling output versus current density.

### DETAILED DESCRIPTION

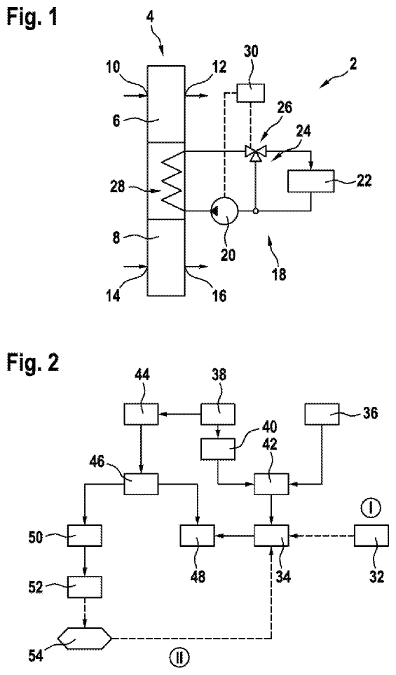

FIG. 1 shows a fuel cell system 2 comprising a fuel cell stack 4, which has an anode side 6 and a cathode side 8. The anode side 6 comprises an anode inlet 10 and an anode outlet 12. The cathode side 8 comprises a cathode inlet 14 and a cathode outlet 16. The details of supplying the fuel cell stack 4 with reactants are not discussed in more detail in the context of the invention. The fuel cell system 2 also comprises a cooling system 18, which has a coolant pump 20, a cooler 22 through which coolant can flow, a bypass 24 comprising a bypass valve 26 for selectively, at least partially, bridging of the cooler 22 and coolant passages 28 of the fuel cell stack 4 thermally coupled to the fuel cell system 2. A control unit 30 is coupled to the cooling system 18 in order to control the coolant pump 20 and the bypass valve 26.

The bypass valve 26 is, by way of example, designed as a three-way valve. The bypass valve 26 is adjustable between a first position, in which the entire volumetric flow flows through the cooler 22, and a second position, in which the entire volumetric flow flows through the bypass 24. Heating of the fuel cell stack 4 could even be achieved in the second position.

The control unit 30 is designed for determining a flooding risk of the fuel cell system 2 at least once according to current operating conditions of the fuel cell system 2, for determining a maximum permissible temperature gradient based on the determined flooding risk, for operating the coolant pump 20 such that it conveys a volumetric flow of a coolant through the coolant passages 28 of the fuel cell stack 4 and the cooler 22, for actuating the bypass valve 26 such that it divides the volumetric flows through the bypass 24 and the cooler 22, and for limiting a cooling output by limiting the volumetric flow and a status of the bypass valve 26 in order to limit the temperature gradient to the determined maximum permissible temperature gradient.

FIG. 2 shows a method for cooling the fuel cell system 2 by operating the cooling system 18 in a schematic, block-based illustration. In variant I, a flooding risk of the fuel cell system 2 according to current operating conditions of the fuel cell system 2 can be determined as a predictive precontrol 32 process, and a maximum permissible temperature gradient can be determined based on the determined flooding risk. Based on this, in block 34, the coolant pump 20 is operated such that it conveys a volumetric flow of a coolant through the coolant passages 28 of the fuel cell stack 4 and the cooler 22, and the bypass valve 26 is actuated such that it divides a volumetric flow through the bypass 24 and the cooler 26, whereby the cooling output is limited by limiting the volumetric flow and a status of the bypass valve 26 in order to limit the temperature gradient to the determined maximum permissible temperature gradient. In block 34, the proportion of the maximum possible cooling output to which the cooling output is limited can, for example, be specified.

Various parameters are included in this determination, e.g. an ambient temperature 36 and a speed 38 of a vehicle comprising the fuel cell system 2. Resulting thereby are a cooling capacity 40 of the cooler 22 and a maximum possible cooling output 42. An electrical output 44 of the fuel cell system 2 results in a output loss 46, whereby a first part 48 is compensated for by the cooling system 18, and a second part 50 is accumulated in the fuel cell stack 4 or a structure. The result is a temperature gradient 52 in the fuel cell stack 4.

In variant II, which can be used on its own or in combination with variant I, the current temperature gradient 52 is compared with the specified maximum temperature gradient 54 and if the amount is exceeded, the cooling output is reduced.

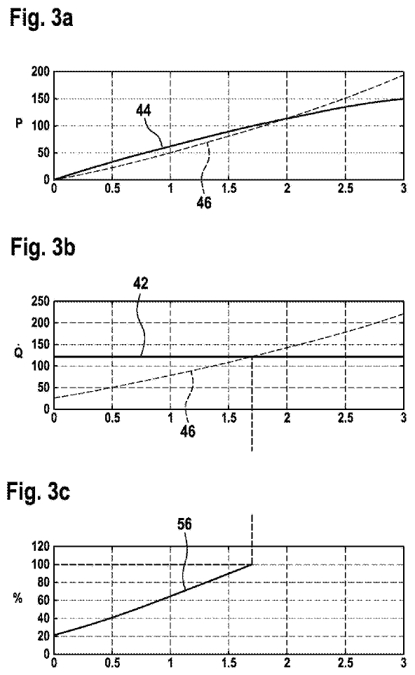

FIGS. 3a, 3b, 3c show three diagrams, one above the other. FIG. 3a shows the electrical output 44 of the fuel cell stack 4 and the output loss 46 in each case over the current density J, with numbering on the axes being purely by way of example. FIG. 3b shows a comparison of the output loss 46 of the fuel cell stack 4 and the maximum possible cooling output 42, which is significantly higher than the output loss 46 for lower current densities. There is a risk of flooding, in particular at very low current densities. On this basis, FIG. 3c shows a throttling factor 56 in %, at which the cooling output of the cooling system 18 is throttled. At very low current densities J, the cooling output of the cooling system is, e.g., throttled back to 20%, while from an intersection point between the theoretical maximum output 42 of the cooling system 18 and the output loss 46 of the fuel cell stack 4, the throttling is completely lifted at higher current densities. The risk of flooding is significantly reduced as a result.

1. A method for cooling a fuel cell system (2) by operating a cooling system (18), comprising a coolant pump (20), a cooler (22) through which coolant can flow, a bypass (24) with a bypass valve (26) for selectively bridging the cooler (22), and coolant passages (28) of a fuel cell stack (4) thermally coupled to the fuel cell system (2), said method comprising:
Determining, via a computer, a flooding risk of the fuel cell system (2) at least once according to current operating conditions of the fuel cell system (2),
determining, via the computer, a maximum permissible temperature gradient based on the determined flooding risk,
operating, via the computer, the coolant pump (20) such that it conveys a volumetric flow of a coolant through the coolant passages (28) and the cooler (22),
actuating, via the computer, the bypass valve (26) such that it divides the volumetric flow through the bypass (24) and the cooler (22), and
limiting, via the computer, a cooling output by limiting the volumetric flow and a status of the bypass valve (26) in order to limit the temperature gradient to the determined maximum permissible temperature gradient.

2. The method according to claim 1,
wherein the actuation is performed in at least a predictive manner.

3. The method according to claim 1,
wherein the actuation is performed based on measurement data or an estimated status of the fuel cell system (2) in a feedback regulation process.

4. The method according to claim 3,
further comprising comparing an actual temperature gradient of the fuel cell system (2) with the maximum temperature gradient, wherein the cooling output is reduced if the temperature gradient exceeds the maximum temperature gradient.

5. The method according to claim 1,
wherein determining the flooding risk comprises detecting a relative humidity at a cathode input (14) and/or an anode input (10), wherein the maximum permissible temperature gradient is reduced as the relative humidity increases.

6. The method according to claim 1,
wherein determining the flooding risk comprises detecting a current temperature in the fuel cell system (2) and comparing it with a target temperature, wherein the maximum temperature gradient is selected to be greater as the difference between the current temperature and the target temperature decreases.

7. The method according to claim 1,
wherein the determination of the flooding risk comprises estimating the water content of a membrane of the fuel cell system (2) by means of an impedance measurement,
wherein the maximum temperature gradient is increased at a lower water content of the membrane.

8. A fuel cell system (2), comprising at least one fuel cell stack (4), a cooling system (18) comprising a coolant pump (20), a cooler (22) through which coolant can flow, a bypass (24) with a bypass valve (26) for selectively bridging the cooler (22) and a coolant passage (28) of a fuel cell stack (4) thermally coupled to the fuel cell system (2), and a control unitcomputer (30) coupled to the cooling system (18), wherein the computer (30) is configured to:
determine a flooding risk of the fuel cell system (2) at least once according to current operating conditions of the fuel cell system (2),
determine a maximum permissible temperature gradient based on the determined flooding risk,
operate the coolant pump (20) such that it conveys a volumetric flow of a coolant through the coolant passages (28) and the cooler (22),
actuate the bypass valve (26) such that it divides through the bypass (24) and the cooler (22), and
limit a cooling output by limiting the volumetric flow and a status of the bypass valve (26) in order to limit the temperature gradient to the determined maximum permissible temperature gradient.

9. The fuel cell system (2) according to claim 8, wherein the computer (30) is designed to determine the flooding risk by detecting a relative humidity at a cathode input (14) and/or an anode input (10), wherein the maximum permissible temperature gradient is reduced as the relative humidity increases, and/or by detecting a current temperature in the fuel cell system (2) and comparing it with a target temperature, wherein the maximum temperature gradient is selected to be greater as the difference between the current temperature and the target temperature decreases.

10. The fuel cell system (2) according to claim 8,
further comprising an impedance measuring device,
wherein the computer (30) is designed to perform the flooding risk by estimating the water content of a membrane of the fuel cell system (2) by means of an impedance measurement by the impedance measuring device,
wherein the maximum temperature gradient is increased at a lower water content of the membrane.
